(19) United States
(12) Patent Application Publication
(10) Pub. No.: US 2026/0309728 A1
(43) Pub. Date: Oct. 8, 2026

(54) REAGENT STORAGE, ANALYZER, AND COOLING METHOD

(71) Applicant: CANON KABUSHIKI KAISHA, Tokyo (JP)

(72) Inventor: Shin IIDA, Otawara-shi (JP)

(73) Assignee: CANON KABUSHIKI KAISHA, Tokyo (JP)

(21) Appl. No.: 19/574,577

(22) Filed: Mar. 23, 2026

(30) Foreign Application Priority Data
Apr. 3, 2025 (JP) 2025-061833

(51) Int. Cl. G01N 35/00

(52) U.S. Cl. CPC G01N 35/00584; G01N 2035/00316; G01N 2035/00435; G01N 2035/00445

(57) ABSTRACT

A reagent storage of an embodiment includes a housing, a door, and a blower. The housing is formed of a storage capable of storing reagent bottles under refrigeration conditions and an opening communicating with the storage. The door switches between a closed state in which the door covers the opening and an open state in which the door leaves at least a portion of the opening open. The blower blows air from inside the storage toward the opening.

### CROSS-REFERENCE TO RELATED APPLICATION

The present application claims priority based on Japanese Patent Application No. 2025- 061833 filed Apr. 3, 2025, the content of which is incorporated herein by reference.

### FIELD

The embodiments disclosed in this specification and drawings relate to a reagent storage, an analyzer, and a cooling method.

### BACKGROUND

Conventionally, automated analyzers for clinical testing are known. These automated analyzers mix a certain amount of a biological sample (hereinafter referred to as a sample) such as blood or urine with a reagent to cause a reaction and irradiate the mixture with transmitted or scattered light to measure the amount of light, thereby determining the concentration and activity of the measurement target substance, as well as the time required for the change. Such analyzers are equipped with a reagent storage having a cooling function.

The reagent storage has an opening for inserting and removing reagents and a door attached to the opening. Reagent bottles containing reagents are stored in the reagent storage, but the door is always open when inserting or removing reagent bottles, which may cause localized temperature increases inside the reagent storage near the door.

With conventional technology, even if the temperature inside the reagent storage is locally increased, it is impossible to increase the cooling efficiency in that area. A temperature increase inside the reagent storage can cause reagent deterioration. In this case, there is a possibility that an error in an analyzer will occur due to reagent deterioration.

### BRIEF DESCRIPTION OF THE DRAWINGS

FIG. 1 is a schematic diagram illustrating an analyzer according to an embodiment.

FIG. 2 is an exploded perspective view illustrating a reagent storage according to an embodiment.

FIG. 3 is a flowchart illustrating a cooling method for the reagent storage according to an embodiment.

FIG. 4 is a schematic diagram illustrating the results of a simulation of a temperature distribution in a storage when a door is open and no air is being blown by a blower.

FIG. 5 is a schematic diagram illustrating the results of a simulation of air circulation occurring near an opening when the door is open.

### DETAILED DESCRIPTION

Hereinafter, a reagent storage, an analyzer, and a cooling method according to an embodiment will be described with reference to the drawings.

A reagent storage according to an embodiment includes a housing, a door, and a blower. The housing is formed of a storage capable of storing reagent bottles under refrigeration conditions, and an opening communicating with the storage. The door switches between a closed state in which the door covers the opening and an open state in which the door leaves at least a portion of the opening open. The blower blows air from the inside of the storage toward the opening.

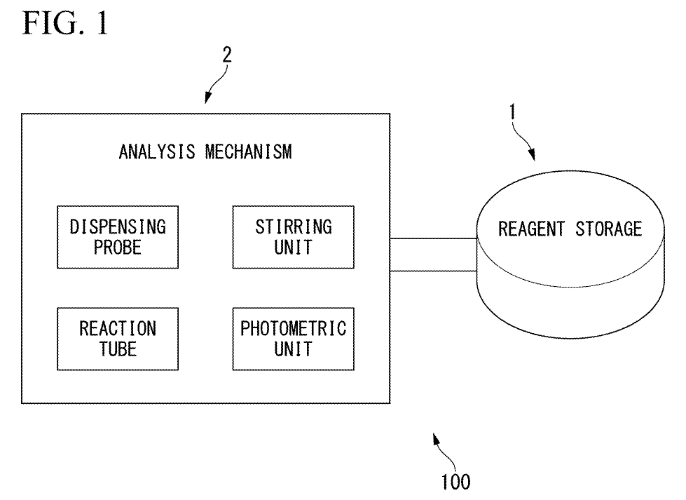

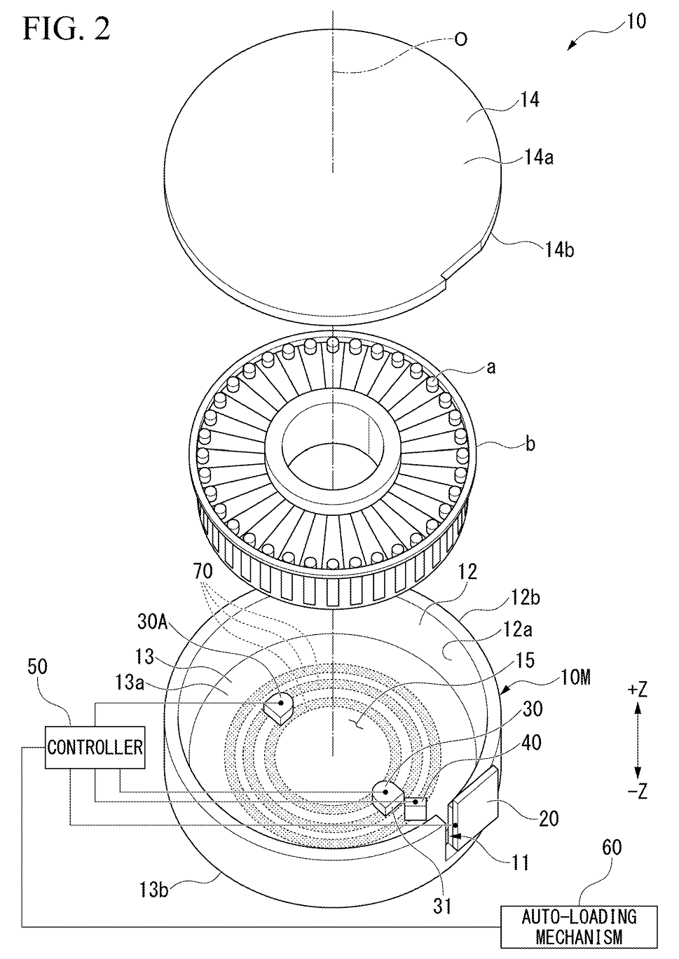

FIG. 1 is a schematic diagram illustrating an analyzer 100 according to an embodiment. FIG. 2 is an exploded perspective view illustrating a reagent storage 1 according to an embodiment. As illustrated in FIG. 1, the analyzer 100 includes a reagent storage 1 and an analysis mechanism 2. As illustrated in FIG. 2, the reagent storage 1 stores reagent bottles a. The reagent bottles a store predetermined reagents. The reagent storage 1 keeps the reagent bottles a and the reagents stored therein cool.

The analysis mechanism 2 performs analysis using the reagents stored in the reagent bottles a. As illustrated in FIG. 1, the analysis mechanism 2 may include, for example, a dispensing probe that dispenses the reagent from the reagent bottle a, a reaction tube that reacts a sample (e.g., blood, body fluid, or the like) with the reagent, a stirring unit that stirs the reaction tube, and a photometric unit that performs optical analysis of the mixture of the sample and the reagent stored in the reaction tube. However, the specific configuration of the analysis mechanism 2 is not limited to this and can be modified as appropriate as long as it is a mechanism that performs analysis using reagents. The reagent storage 1 may be used with a mechanism different from the analysis mechanism 2, or the reagent storage 1 may be used alone.

As illustrated in FIG. 2, the reagent storage 1 includes a housing 10, a door 20, a blower 30, a temperature acquirer 40, a controller 50, an auto-loading mechanism 60, and a refrigerant flow path 70. The housing 10 has a reagent rack b that stores a plurality of reagent bottles a. The reagent rack b is configured to be rotatable around a rotation axis O.

### Definition of directions

Here, a direction parallel to the rotation axis O is referred to as a Z direction or axial direction Z. One direction along the axial direction Z is referred to as a +Z direction or upward direction. The direction opposite to the +Z direction is referred to as a -Z direction or downward direction. A cross section perpendicular to the axial direction Z is referred to as a transverse cross section. A view in the axial direction Z is referred to as a planar view. A direction orthogonal to the rotation axis O when viewed in the axial direction Z is referred to as a radial direction. A direction approaching the rotation axis O in the radial direction is referred to as a radially inner side, and a direction away from the rotation axis O is referred to as a radially outer side. A direction circumferentially around the rotation axis O as viewed in the axial direction Z is referred to as a circumferential direction.

The housing 10 includes a cylindrical main body 10M with a bottom and a lid 14. The main body 10M has a cylindrical wall 12 and a bottom 13. The central axis of the cylindrical wall 12 (i.e., the central axis of the housing 10) coincides with the rotation axis O. Hereinafter, the rotation axis O may be referred to as the central axis O.

The wall 12 has an inner surface 12a facing the radially inner side and an outer surface 12b facing the radially outer side. The bottom 13 closes the lower end of the wall 12. The bottom 13 is connected to the lower end of the wall 12. The bottom 13 has an upper bottom surface 13a facing upward and a lower bottom surface 13b facing downward.

The lid 14 is configured to be removable from the open end of the main body 10M. The lid 14 has a circular shape in a planar view. The lid 14 has an upper lid surface 14a and a lower lid surface 14b. In a state in which the lid 14 is attached to the main body 10M (hereinafter referred to as an attached state), the upper lid surface 14a faces upward, and the lower lid surface 14b faces downward. In the attached state, the lower lid surface 14b contacts the open end of the main body 10M. With the lid 14 attached to the main body 10M, the housing 10 takes on a hollow cylindrical shape.

The housing 10 has a storage 15 formed thereinside. The storage 15 is a space capable of storing the reagent bottles a under refrigeration conditions. The space surrounded by the inner surface 12a, the upper bottom surface 13a, and the lower lid surface 14b corresponds to the storage15. The reagent rack b is stored in the storage 15, thereby storing the reagent bottles a.

In the storage15, the reagent bottles a stored therein are kept cool at a preset temperature. The refrigerant flow path 70 through which a refrigerant that cools the storage 15 flows is formed in the housing 10. Accordingly, the air within the storage 15 is cooled. For example, the refrigerant flow path 70 may be formed inside the bottom 13. The refrigerant flow path 70 may also be formed outside the bottom 13, as long as it is capable of cooling the storage 15. However, the configuration for cooling the storage 15 can be modified as appropriate.

The reagent storage 1 may have a rotation mechanism (not shown) that rotates the reagent rack b around the rotation axis O. The rotation mechanism may be configured to be able to arbitrarily control the positions of the reagent bottles a in the circumferential direction.

The housing 10 is provided with an opening 11 that communicates with the storage 15. The opening 11 is a hole that opens to the outer surface 12b and penetrates the wall 12 in the radial direction. This opening 11 connects the storage 15 to the space outside the housing 10 (external space). However, the opening 11 does not have to penetrate the wall 12, and it may penetrate the bottom 13 in the axial direction Z or penetrate the lid 14 in the axial direction Z. That is, the opening 11 may open to the lower bottom surface 13b or the upper lid surface 14a.

The door 20 is configured to be switchable between a closed state and an open state. In other words, the door 20 is configured to be openable and closable. The door 20 is switched between the closed state and the open state under the control of the controller(processing circuitry) 50. The closed state is a state in which the door 20 covers (blocks) the opening 11. The open state is a state in which the door 20 exposes at least a portion of the opening 11. The open state of the door 20 allows the auto-loading mechanism 60 to insert or remove reagent bottles a (which will be described below). The door 20 is provided on the outer surface 12b. The door 20 slides in the circumferential direction to switch between the closed state and the open state.

As long as the door 20 can be switched between the closed state and the open state, the specific configuration and arrangement of the door 20 can be modified as appropriate. For example, the door 20 may be provided on the inner surface 12a. If the opening 11 penetrates the bottom 13, the door 20 may be provided on the upper bottom surface 13a or the lower bottom surface 13b. If the opening 11 penetrates the lid 14, the door 20 may be provided on the upper lid surface 14a or the lower lid surface 14b. The door 20 may be configured to be open and closed by a motion other than a sliding motion (e.g., a rotational motion, etc.).

The blower 30 blows air from inside the storage 15 toward the opening 11. Accordingly, the blower 30 blows air cooled in the storage 15. The blower 30 is provided at a position corresponding to the refrigerant flow path 70. For example, the blower 30 may be provided on the upper bottom surface 13a at a position that overlaps the position where the refrigerant flow path 70 is formed in a planar view. The blower 30 is provided on the upper bottom surface 13a at a position between the central axis O and the opening 11 in a planar view. More specifically, the blower 30 may be located on the radially inner side of the midpoint between the central axis O and the inner surface 12a in the radial direction.

The blower 30 has a vent 31 facing the opening 11. This vent 31 allows air to be blown toward the opening 11. The blower 30 may be, for example, a sirocco fan. However, as long as it is possible to blow air from inside the storage 15 toward the opening 11, the specific configuration of the blower 30 is not limited and can be modified as appropriate.

The blower 30 may be provided at a position other than the position where the refrigerant flow path 70 is formed in a planar view. The blower 30 is preferably provided near the refrigerant flow path 70. As long as it is possible to blow air from inside the storage 15 toward the opening 11, the blower 30 may be provided at a position other than the upper bottom surface 13a. For example, the blower 30 may be provided on the inner surface 12a or the lower lid surface 14b. In either case, it is preferable that the vent 31 face the opening 11.

The reagent storage 1 may further include an auxiliary blower 30A in addition to the blower 30. The auxiliary blower 30A blows air from inside the storage 15 in a direction different from the direction of air blown by the blower 30. The auxiliary blower 30A may, for example, blow air to circulate air throughout the storage 15. The auxiliary blower 30A may, for example, blow air continuously. A configuration in which the reagent storage 1 does not include the auxiliary blower 30A that blows air continuously is advantageous in that it is less likely to cause evaporation of a reagent.

The temperature acquirer 40 acquires the temperature of the storage 15. The temperature acquirer 40 is a temperature sensor. For example, the temperature acquirer 40 may be provided near the opening 11 and acquire the temperature near the opening 11. The temperature acquirer 40 may acquire the temperature of one location in the storage 15 as the temperature of the storage 15, may acquire the temperatures of a plurality of locations in the storage 15, or may acquire a temperature distribution in part of or the entire storage 15. The temperature acquirer 40 may indirectly acquire the temperature of the storage 15 by acquiring the temperature of a portion in contact with the storage 15 (i.e., the housing 10). The temperature acquirer 40 outputs the acquired temperature to the controller 50. The temperature acquirer 40 may continuously acquire the temperature of the storage 15, or may acquire the temperature of the storage 15 at a specific timing (for example, when the door 20 switches from the open state to the closed state).

The auto-loading mechanism 60 automatically transports the reagent bottles a to the reagent storage 1 and inserts/removes the reagent bottles a into/from the storage 15. The auto-loading mechanism 60 transports and inserts/removes the reagent bottles a, for example, on the basis of the control of the controller 50 (auto-loading control function). More specifically, the auto-loading mechanism 60 may transport the reagent bottles a containing reagents (hereinafter referred to as new bottles) to the reagent storage 1. The auto-loading mechanism 60 may also remove a reagent bottle a containing less than a predetermined amount of reagent (hereinafter referred to as a bottle with insufficient reagent) from the storage 15 and insert a new bottle into the storage 15. That is, the auto-loading mechanism 60 may be a mechanism that replenishes reagents in the storage 15 by inserting and removing reagent bottles a. The auto-loading mechanism 60 inserts/removes the reagent bottles a into/from the reagent rack b stored in the storage 15.

The controller (processing circuitry) 50 has at least a door control function, a temperature acquisition function, an air blowing control function, and an auto-loading control function. The controller 50 realizes these functions by, for example, a hardware processor executing a program stored in a storage device (storage circuit).

The hardware processor refers to, for example, circuitry such as a central processing unit (CPU), a graphics processing unit (GPU), an application specific integrated circuit (ASIC), or a programmable logic device (e.g., simple programmable logic device (SPLD) or complex programmable logic device (CPLD), and a field programmable gate array (FPGA)). Instead of storing a program in a storage device, the program may be directly embedded in the circuit of the hardware processor. In this case, the hardware processor realizes the functions by reading and executing the program embedded in the circuit. The hardware processor is not limited to being configured as a single circuit and may be configured as a single hardware processor combining a plurality of independent circuits to realize each function. Furthermore, a plurality of components may be integrated into a single hardware processor to realize each function.

The door control function controls switching of the door 20 between the open state and the closed state. For example, the door control function controls (switches) the door 20 to the open state when the auto-loading mechanism 60 inserts/removes reagent bottles a into/from the storage 15. In other words, the door control function controls (switches) the door 20 to the open state when the auto-loading function causes the auto-loading mechanism 60 to insert or remove reagent bottles a. The door control function controls (switches) the door 20 to the closed state when the auto-loading mechanism 60 has finished

The temperature acquisition function acquires the temperature of the storage 15. The temperature acquisition function is realized when the controller 50 acquires the temperature output from the temperature acquirer 40.

The air blowing control function controls the air blowing by the blower 30. The air blowing control function causes the blower 30 to blow air, for example, after the auto-loading mechanism 60 has finished inserting or removing reagent bottles a and the door 20 has switched from the open state to the closed state by the door control function. The air blowing control function controls the strength of the air blowing by the blower 30 on the basis of the temperature of the storage 15 acquired by the temperature acquisition function. Specifically, the acquired temperature is compared with a preset temperature threshold, and the higher the acquired temperature, the stronger the air blowing strength, and the lower the acquired temperature, the weaker the air blowing strength. The air blowing control function may stop the air blowing by the blower 30 when the acquired temperature is equal to or lower than a temperature that is appropriate for storing reagents. In this case, the generation of convection in the reagent storage 1 is suppressed, thereby preventing evaporation of the reagents. The air blowing control function may control the air blowing by the auxiliary blower 30A.

The auto-loading control function controls insertion/removal of reagent bottles a into/from the storage 15 by the auto-loading mechanism 60. For example, the auto-loading control function may detect the aforementioned bottle with insufficient reagent. Then, upon detection, the auto-loading control function may cause the auto-loading mechanism 60 to transport the aforementioned new bottle and insert or remove a reagent bottle a. The auto-loading control mechanism may also control the rotation mechanism. For example, the auto-loading control mechanism may control the rotation mechanism to rotate the reagent rack b around the rotation axis O such that the bottle with insufficient reagent faces the opening 11 in the radial direction. This allows the auto-loading mechanism 60 to smoothly remove the bottle with insufficient reagent and insert a new bottle.

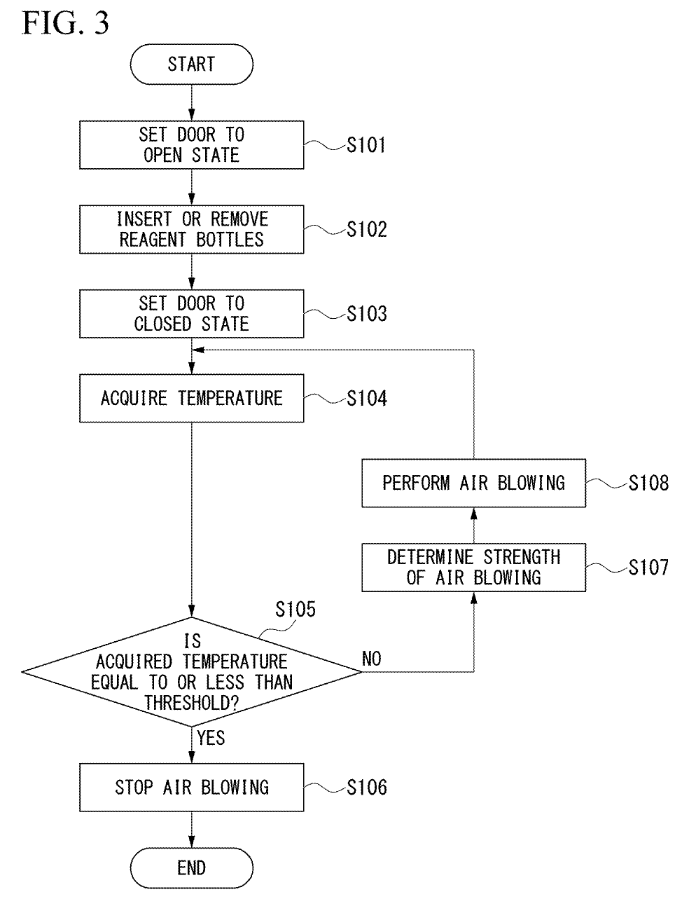

Next, processing in the reagent storage 1 will be described. FIG. 3 is a flowchart illustrating an example of processing in the reagent storage 1. The processing shown in FIG. 3 is initiated, for example, when a manager of the reagent storage 1 inputs an instruction for analysis processing or replacement of a bottle with insufficient reagent via a terminal device (not shown) connected to the reagent storage 1. First, the door control function opens the door 20 (step S101). Subsequently, the auto-loading control function controls the auto-loading mechanism 60 to cause the auto-loading mechanism 60 to insert or remove reagent bottles a (step S102). Subsequently, the door control function closes the door 20 (step S103). Subsequently, the temperature acquirer 40 (temperature acquisition function) acquires the temperature of the storage 15 (step S104). Subsequently, it is determined whether the temperature acquired by the air blowing control function is equal to or less than a threshold (step S105). If it is determined that the acquired temperature is not equal to or less than the threshold (step S105; NO), the air blowing control function determines the air blowing strength on the basis of the temperature acquired by the temperature acquisition function (step S107). Subsequently, the air blowing control function controls the blower 30 on the basis of the determined strength, causing the blower 30 to blow air at the strength (step S108). The processing then returns to step S104, where the temperature of the storage 15 is acquired and subsequent processing is repeated. On the other hand, if it is determined that the acquired temperature is equal to or less than the threshold (step S105; YES), the air blowing control function stops blowing air (step S106). Accordingly, the controller 50 ends the processing illustrated in FIG. 3.

Next, the operation of the reagent storage 1 configured as described above will be described.

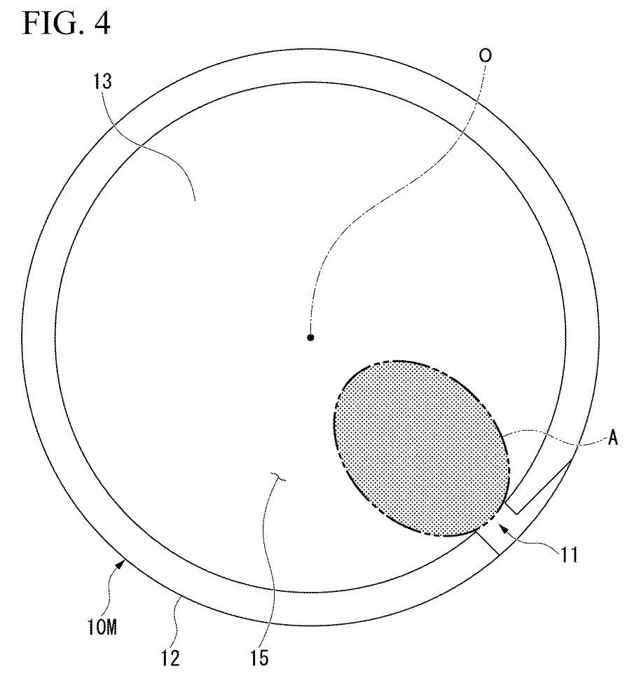

FIG. 4 is a schematic diagram illustrating the results of a simulation of the temperature distribution in the storage 15 when the door 20 is open and no air is being blown by the blower 30. In FIG. 4, area A indicates an area where the temperature was particularly high area in the storage 15.

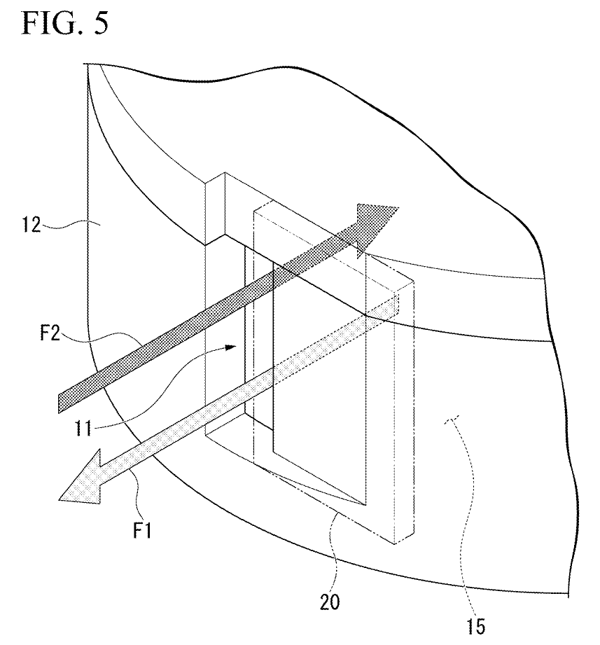

FIG. 5 is a schematic diagram illustrating the results of a simulation of the air circulation occurring near the opening 11 when the door 20 is open. Arrows F1 and F2 in FIG. 5 indicate air flow. Arrow F1 indicates the outflow of cooled air from the inside of the reagent storage 1 to the outside space. Arrow F2 indicates the inflow of air not cooled by the reagent storage 1 from the outside space into the reagent storage 1.

In this manner, the inventors of the present application discovered that, when the door 20 is open, air convection causes a particular temperature rise near the opening 11. To address this issue, the reagent storage 1 employs a configuration in which the blower 30 blows air toward the opening 11, actively creating air convection near the opening 11. This eliminates temperature rise near the opening 11. Eliminating temperature rise near the opening 11 also reduces the decrease in cooling efficiency of the reagent storage 1 caused by the door 20 being open.

Here, if air is blown while the door 20 is open, air flows as indicated by arrow F2 in FIG. 5, potentially impeding cooling near the opening 11. By blowing air after insertion or removal of reagent bottles a is complete and the door 20 is closed rather than open, this problem can be avoided and temperature rise near the opening 11 can be rapidly eliminated. Furthermore, by acquiring the temperature of the storage 15 (e.g., near the opening 11) and adjusting the air blowing strength on the basis of the acquired temperature, temperature rise near the opening 11 can be more efficiently eliminated.

According to at least one embodiment described above, the reagent storage includes a housing having a storage capable of storing reagent bottles and keeping the stored reagent bottles cool, an opening communicating with the storage, a door configured to switch between a closed state in which the door covers the opening and an open state in which the doors leaves at least a portion of the opening open, and a blower configured to blow air from inside the storage toward the opening, thereby minimizing reduction in the cooling efficiency of the reagent storage caused by opening of the door provided at the opening of the housing.

Although several embodiments have been described, these embodiments are presented as examples and are not intended to limit the scope of the invention. These embodiments can be implemented in various other forms, and various omissions, substitutions, and modifications can be made without departing from the spirit of the invention. These embodiments and modifications thereof are included in the scope and spirit of the invention, as well as the scope of the invention described in the claims and equivalents thereof.

What is claimed is:

1. A reagent storage comprising:
a housing having a storage capable of storing reagent bottles under refrigeration conditions and an opening communicating with the storage;
a door configured to switch between a closed state in which the door covers the opening and an open state in which the door leaves at least a portion of the opening open; and
a blower configured to blow air from inside the storage toward the opening.

2. The reagent storage according to claim 1, wherein the blower blows air after the door switches from the open state to the closed state.

3. The reagent storage according to claim 2, further comprising an auto-loading mechanism configured to insert/remove the reagent bottles into/from the storage;
wherein,
when the auto-loading mechanism has finished inserting or removing the reagent bottles, the door switches from the open state to the closed state,
and the blower blows air after the door switches to the closed state.

4. The reagent storage according to claim 1, further comprising:
a temperature acquirer configured to acquire a temperature of the storage; and
processing circuitry configured controller to control a strength of the air blowing by the blower based on the acquired temperature.

5. The reagent storage according to claim 4, wherein
the processing circuitry configured to controller stop the air blowing by the blower
when the acquired temperature is equal to or lower than a threshold.

6. The reagent storage according to claim 1, wherein
a refrigerant flow path is formed in the housing, and
the blower is provided at a position corresponding to the refrigerant flow path.

7. An analyzer comprising:
the reagent storage according to claim 1; and
an analysis mechanism configured to perform analysis using reagents stored in the reagent bottles.

8. A cooling method in a reagent storage comprising:
a housing having a storage capable of storing reagent bottles under refrigeration conditions, and an opening communicating with the storage; and
a door configured to switch between a closed state in which the door covers the opening and an open state in which the door leaves at least a portion of the opening open,
the cooling method comprising blowing air from inside the storage toward the opening.

9. The cooling method according to claim 8, wherein
the air blowing is performed
after the door is switched from the open state to the closed state.

10. The cooling method according to claim 8, further comprising:
acquiring a temperature of the storage; and
controlling the strength of the air blowing based on the acquired temperature.
